(19) United States
(12) Patent Application Publication
(10) Pub. No.: US 2008/0112319 A1
(43) Pub. Date: May 15, 2008

(54) Traffic shaper

(75) Inventors: Atsushi Saegusa, Atsugi-shi (JP); Masato Aketo, Atsugi-shi (JP)

Correspondence Address: GREER, BURNS & CRAIN, 300 S WACKER DR, 25TH FLOOR, CHICAGO, IL, 60606, US

(73) Assignee: Anritsu Corporation, Atsugi-shi (JP)

(21) Appl. No.: 11/983,871

(22) Filed: Nov. 13, 2007

(30) Foreign Application Priority Data
Nov. 14, 2006 (JP) 2006-307326

(51) Int. Cl. G08C 15/00

(52) U.S. Cl. 370/230.1

(57) ABSTRACT

A traffic shaper having a management information collecting unit which collects management information stored in a specific device outside of the traffic shaper and sets a bandwidth control condition based on the management information, and a traffic control unit which controls a bandwidth based on the bandwidth control condition. The traffic shaper is connected between an external network and a relay apparatus connecting a plurality of access endpoints whose bandwidth to the external network are to be controlled by the traffic shaper. The management information collecting unit regularly collects the management information to automatically reflect updated management information in the specific device outside of the traffic shaper.

### BACKGROUND OF THE INVENTION

1. Field of the Invention

The present invention relates to a traffic shaper controlling a bandwidth of data flow transmitted or received in a communication network flow. More specifically, the present invention relates to a traffic shaper controlling a communication bandwidth available to a plurality of access endpoints on the same communication line for external network connection in a system in which the communication line for external network connection is shared among the plurality of access endpoints.

2. Description of the Related Art

In recent years, universal distribution of networks by various Internet connection services has increased the bandwidth used by users. In a CATV Internet connection service, as an example of the Internet connection services, in which a plurality of user terminals can communicate over the Internet by connecting the user terminals to one cable modem termination system (CMTS) via cable modems (CMs), a bandwidth of a service line connecting the CTMS to the Internet is shared among the user terminals. However, because of a nature of the Internet protocol, the problem occurs that in a service line portion in which the bandwidth is shared among the terminals, a part of the terminals occupy the larger bandwidth while the other terminals can secure only insufficient bandwidth, resulting in an unequal state of bandwidth sharing. Due to this, each of Internet service providers (ISPs) providing Internet connection services normally installs an apparatus controlling a bandwidth sharing state (hereinafter, “traffic shaper”) to prevent the bandwidth from being occupied by part of terminals.

The bandwidth controlled by the traffic shaper is allocated not only to every terminal but also to every sub-network including a plurality of terminals or to every application operating in one terminal. A unit such as a terminal, a sub-network or an application which is controlled and to which a bandwidth is allocated will be referred to as “access endpoint” hereinafter. While the terminals are electronic computers (PCs) in most cases, they include all devices having network interfaces such as CMs and home electric appliances.

As the traffic shaper stated above, there is an apparatus disclosed in, for example, Japanese Patent Application Laid-Open No. 2006-229432.

However, the conventional traffic shaper has the following problems to be solved.

For each Internet connection service, the ISP generally prepares a plurality of fee structures different in a maximum allowable bandwidth, a minimum guaranteed bandwidth or the like so as to flexibly deal with various requests from users. In this case, the ISP needs to input and set identification information for identifying access endpoints and service bandwidth information such as contract bandwidth information corresponding to the respective identification information to the traffic shaper in advance. The service bandwidth information includes, but are not limited thereto, a maximum uplink bandwidth, a maximum downlink bandwidth, a guaranteed uplink bandwidth, a guaranteed downlink bandwidth, a maximum uplink burst, a maximum downlink burst, and the like. An IP address is normally used as an access endpoint identification information (identification number). However, the IP address of each access endpoint is often allocated automatically to the access endpoint when a corresponding terminal is turned on or is connected to the communication line. Due to this, the IP address may possibly change over time. As a result, it has been practically impossible to set bandwidth management conditions different among the access endpoints to the traffic shaper.

To solve the problem, there is known a method of including a bandwidth management function in a relay apparatus such as a CMTS. This method has, however, the following problem. Many resources of the relay apparatus are consumed for the bandwidth management, causing a problem that the relay apparatus can insufficiently demonstrate its performances. Moreover, in case of an ISP using a plurality of relay apparatus, if the traffic shaper is provided to each relay apparatus, cost disadvantageously increases. Besides, if one service line is shared among such a plurality of relay apparatus, a line utilization efficiency problem occurs. Namely, even though a bandwidth used by a certain relay apparatus has a margin to spare, the other relay apparatus cannot use the margin.

There is known, as another bandwidth management method, a bandwidth management method of limiting a packet related to a specific application without setting bandwidth management conditions different among access endpoints to the traffic shaper. However, this method cannot solve the fundamental problem of the setting of bandwidth management conditions different among access endpoints to the traffic shaper. Due to this, even if the ISP can divide a bandwidth (a shared bandwidth) shared among the access endpoints by the number of access endpoints and distribute the bandwidths to the respective access endpoints evenly, it cannot distribute the shared bandwidth proportionally according to service bandwidths different among the access endpoints.

### SUMMARY OF THE INVENTION

The present invention has been made to solve the conventional problems. An object of the present invention is to provide a traffic shaper capable of automatically acquiring bandwidth management conditions different among a plurality of access endpoints and exercising a bandwidth control.

A traffic shaper (1) according to one aspect of the present invention is connected between a relay apparatus connecting a plurality of access endpoints different in service bandwidth to the traffic shaper and an external network, and comprises: a management information collecting unit (7) collecting management information stored in a specific device outside of the traffic shaper and including identification information and service bandwidth information on each of the access endpoints, and setting a bandwidth control condition based on the management information; and a traffic control unit (9) controlling a bandwidth available to each of the plurality of access endpoints based on the bandwidth control condition.

With this configuration, the traffic shaper according to the aspect of the present invention acquires the management information from the external specific device and automatically sets the bandwidth control condition. Due to this, there is no need for a network administrator or the like to set the bandwidth control condition to the traffic shaper.

Further, the traffic shaper (1) according to the aspect of the present invention may collect the bandwidth management information from the relay apparatus.

With this configuration, it is possible to more easily construct a network for connection services.

Moreover, if the management information is stored in an MIB in the specific device, the management information collecting unit (7) may function as an SNMP manager acquiring the MIB.

With this configuration, existing resources and an existing protocol are used, so that there is no need to prepare a dedicated storage region and a dedicated communication service in the specific device.

Further, the management information collecting unit (7) may regularly collect the management information.

With this configuration, even if the identification information or the service bandwidth information is updated, the updated information is automatically reflected in the bandwidth control condition used by the traffic shaper (1).

Furthermore, the traffic shaper (1) may be connected to the CTMS (2) serving as the relay apparatus.

With this configuration, in the Internet connection service via cable modems (CMs), the traffic shaper (1) according to the aspect of the present invention automatically acquires the bandwidth control condition. Therefore, the traffic shaper (1) can exercise a bandwidth control over a plurality of terminals different in service bandwidth without need for a network administrator or the like to set the bandwidth control condition to the traffic shaper (1).

Moreover, in the traffic shaper (1) according to the aspect of the present invention, the access endpoints may be terminals and the identification information may be an IP address of each of the terminals.

With this configuration, the traffic shaper (1) according to the aspect of the present invention can exercise a bandwidth control over a packet transmitted or received from an ordinary terminal according to an ordinary Internet protocol.

Further, in the traffic shaper (1) according to the aspect of the present invention, the service bandwidth information may include at least one of a maximum uplink bandwidth and a maximum downlink bandwidth to be controlled to correspond to each of the access endpoints.

With this configuration, the traffic shaper (1) according to the aspect of the present invention can acquire a more definite bandwidth control condition and exercise the bandwidth control based on the condition.

The present invention can provide a traffic shaper capable of automatically acquiring service bandwidth information different among a plurality of access endpoints from an external device, and controlling a bandwidth allocated to each of the access endpoints. Further, even if the identification information or the service bandwidth information of the access endpoints is updated, the updated information is automatically reflected in the bandwidth control condition used by the traffic shaper. If such a traffic shaper is provided to be connected to, for example, the CMTS, the bandwidth shared among a plurality of access endpoints can be distributed to the access endpoints according to service bandwidths of the respective access endpoints without deteriorating performances of the CMTS.

### BRIEF DESCRIPTION OF THE DRAWINGS

FIG. 1 is a system configuration diagram showing a network system including a traffic shaper according to an embodiment of the present invention;

FIG. 2 is a block diagram showing internal functions of the traffic shaper according to the embodiment of the present invention;

FIG. 3 is a flowchart showing operation performed by the traffic shaper according to the embodiment of the present invention;

FIG. 4 is an exemplary IP address table;

FIG. 5 is an exemplary QoS profile table;

FIG. 6 is a block diagram showing a configuration of a traffic control unit constituting the traffic shaper according to the embodiment of the present invention;

FIG. 7 is an exemplary flow identification table stored in a bandwidth control setting storage unit constituting the traffic shaper according to the embodiment of the present invention;

FIG. 8 is a block diagram showing a configuration of a first policer constituting the traffic shaper according to the embodiment of the present invention;

FIG. 9 is a conceptual diagram showing a packet output from the first policer constituting a packet relay apparatus according to the embodiment of the present invention;

FIG. 10 is a block diagram showing a configuration of a second policer constituting the traffic shaper according to the embodiment of the present invention;

FIG. 11 is a flowchart showing operation performed by a traffic control unit constituting the traffic shaper according to the embodiment of the present invention; and

FIG. 12 is a system configuration diagram showing a network system including a traffic shaper according to another embodiment of the present invention.

### DETAILED DESCRIPTION OF THE EMBODIMENTS

Embodiments of the present invention will be described hereinafter with reference to the accompanying drawings.

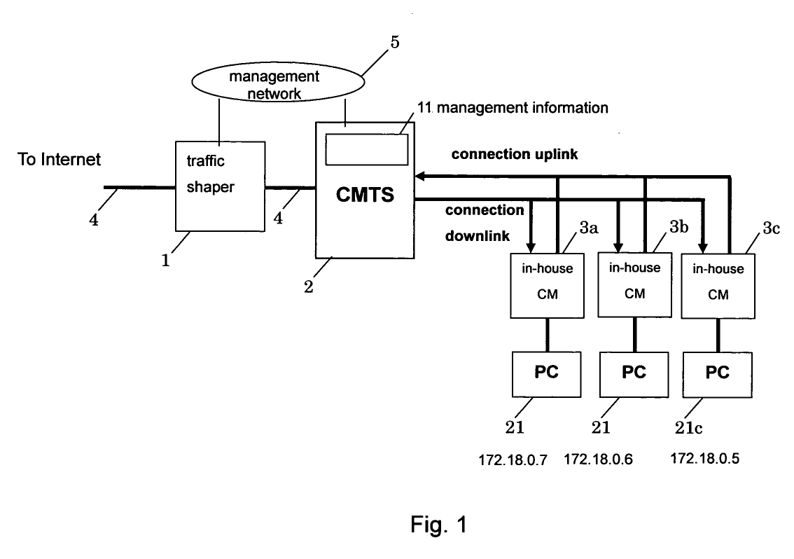

FIG. 1 is a system configuration diagram showing a network system including a traffic shaper according to an embodiment of the present invention. The network system shown in FIG. 1 is a system that provides an Internet connection service via a CATV line. The network system is configured to include a traffic shaper 1, terminals 21a to 21c and cable modems (CMs) 3a to 3c disposed in houses of users, respectively, and a cable modem termination system (CMTS) 2 terminated to a plurality of CMs 3a to 3c. The traffic shaper 1 is connected to the CMTS 2 via a service line 4 in which packets flow from or to the terminals 21a to 21c. The traffic shaper 1 is connected to the CMTS 2 also by a management network 5 used for a network administrator to manage the traffic shaper 1, the CMTS 2 and the like separately from the service line 4.

In the embodiment shown in FIG. 1, management information 11 is stored in the CMTS 2. However, a device in which the management information 11 is stored is not limited to the CMTS 2. Even if the management information 11 is stored in the other relay apparatus, e.g., a management router or a server device connected to the traffic shaper 1 by the management network 5 and managing the management information 11, the present invention is applicable.

Further, the number of CMTSs 2 connected to the traffic shaper 1 is only one in FIG. 1. However, the number of CMTSs 2 connected to the traffic shaper 1 according to the embodiment of the present invention is not limited to one but may be set arbitrarily. Moreover, the number of CMs 3a to 3c connected to one CMTS 2 and the number of terminals 21a to 21c connected to each of the CMs 3a to 3c are not limited to specific numbers.

The CMTS is standardized by DOCSIS (Data Over Cable Service Interface Specifications) that are an international standard for communication services via coaxial cables specified by J.112 Annex.B of the Telecommunication Standardization Union of the International Telecommunication Union (ITU Telecommunication Standardization Union or ITU-T). According to the DOCSIS, one quality of service (QoS) can be set per CM. The CMTS which meets the specifications, i.e., the DOCSIS stores QoS information in a management information base (MIB). The MIB can be acquired via a network or set according to an SNMP (Simple Network Management Protocol) which is a protocol specifying a method of communicating information for monitoring and controlling network devices on an IP network. The network administrator sets or updates the MIB including the QoS information in the CMTS 2 via the management network 5.

According to the DOCSIS, one QoS set to the CMTS 2 corresponds to one CM. If a plurality of terminals is connected to one CM, different QoSs cannot be allocated to the respective terminals, as long as according to the DOCSIS. However, no such restriction is imposed to the traffic shaper 1 according to the embodiment. Due to this, if service bandwidth information on each of the terminals 21a to 21c is provided to the traffic shaper 1 by a method other than a DOCSIS-based method, different bandwidth control conditions among the terminals 21a to 21c can be set. In the embodiment to be described later, an instance of applying the traffic shaper 1 according to the present invention to the CMTS 2 that meets the DOCSIS.

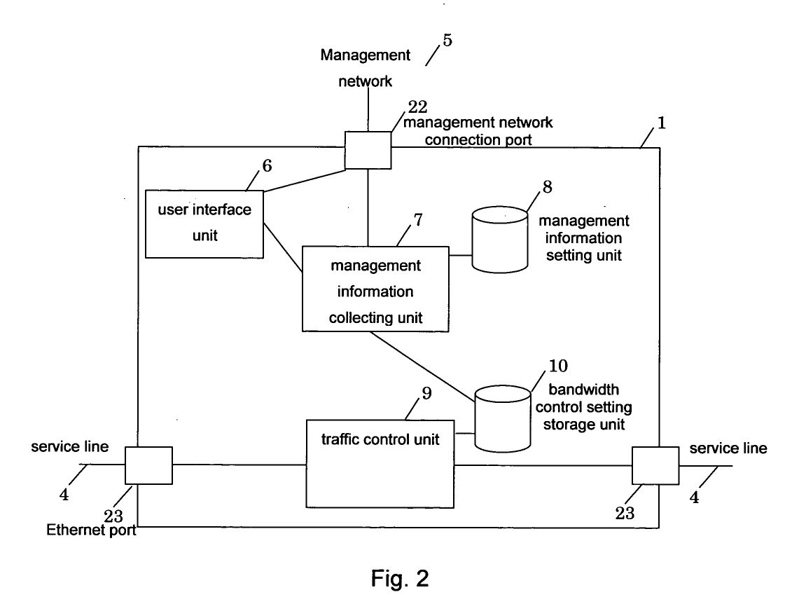

FIG. 2 is a block diagram showing internal functions of the traffic shaper 1 according to the embodiment. The traffic shaper 1 includes a user interface unit 6 to which the network administrator inputs information on the CMTS 2, a management information collecting unit 7 collecting the MIB of the CMTS 2 according to a preset schedule, a management information storage unit 8 storing therein contents of the collected MIB, a bandwidth control setting storage unit 10 extracting bandwidth control conditions from the collected MIB and storing therein the extracted bandwidth control conditions, and a traffic control unit 9 exercising a bandwidth control based on the setting conditions stored in the bandwidth control setting storage unit 10. The traffic shaper 1 is connected to the management network 5 by a management network connection port 22 and to the service line 4 by a service line connection port 23.

The management information collecting unit 7 collects the MIB using the SNMP. The SNMP is a protocol used for a management device called “manager” and a management target device called “agent” to transmit, receive or change the management information called “MIB”. Examples of a method of transmitting or receiving the MIB include a method called “polling” of transmitting the MIB necessary for the agent by causing the manager to designate the MIB to the agent, and a method called “trapping” of spontaneously notifying the manager that the agent detects a certain condition. The traffic shaper 1 according to the embodiment collects the necessary MIB by periodic polling with the management information collecting unit 7 as an SNMP manager and the CMTS 2 as an SNMP agent. Alternatively, the present invention is also applicable to collection of the management information by SNMP trapping.

Furthermore, communication means used by the management information collecting unit 7 to collect the management information is not limited to the SNMP. The other communication means such as a file transfer protocol (FTP) or Telnet can be used to collect the management information.

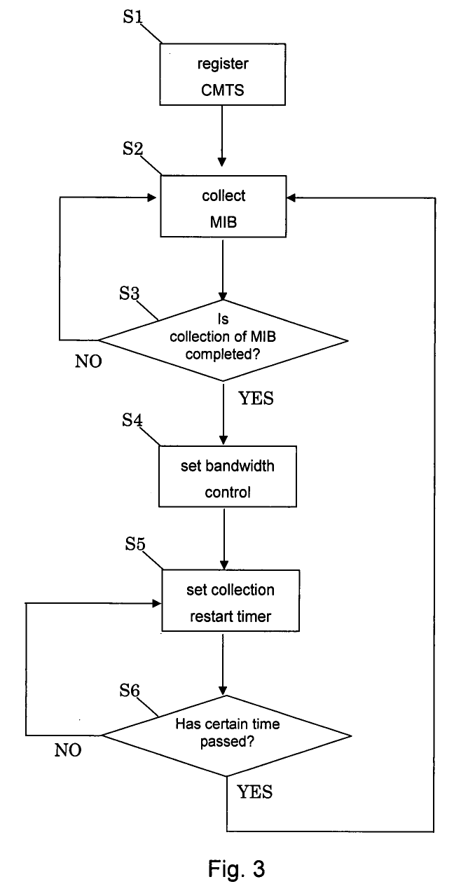

Operation performed by the traffic shaper 1 configured as stated above will be described with reference to FIG. 3.

First, the network administrator registers the CMTS 2 in the traffic shaper 1 via the user interface unit 6 (S1). Registered information includes an IP address of the CMTS 2, a version of the SNMP, and an SNMP community character string. According to the SNMP, a communication cannot be held unless a community character string designated by an inquiry sender coincides with a community character string set to an inquiry destination. Due to this, the community character string acts as a kind of a password.

When the registration of the CMTS 2 is completed, the management information collecting unit 7 starts collecting the MIB and the collected MIB is stored in the management information storage unit 8 (S2). At this time, the management information collecting unit 7 collects the MIB via the management network 5.

When the collection of the MIB is completed (S3), bandwidth control is set to the bandwidth control setting storage unit 10 based on the collected MIB (S4). In the embodiment, information extracted from the MIB and used to set the bandwidth control includes an IP address of each of the terminals 21a, 21b, and 21c as well as such information as a maximum uplink bandwidth, a guaranteed uplink bandwidth, a maximum downlink bandwidth, and a maximum unlink burst corresponding to the IP address. Among the information, the guaranteed uplink bandwidth and the maximum uplink burst are often not set to the MIB. Further, even if the maximum uplink bandwidth and the maximum downlink bandwidth are acquired, they are not necessarily used for the bandwidth control.

When the setting of the bandwidth control to the bandwidth control setting storage unit 10 is completed, the traffic control unit 9 starts exercising the bandwidth control. A configuration of the traffic control unit 9 and an operation performed by the traffic control unit 9 will be described later.

The traffic shaper 1 starts a collection restart timer (not shown) in parallel to the start of the bandwidth control (S5), and regularly and repeatedly executes the steps S2 to S4 after passage of predetermined time (S6). This is intended to make the bandwidth control correspond to dynamic changes in the IP addresses of the terminals 21a to 21c and to reflect the update of the MIB in the CMTS 2 made by the network administrator in the bandwidth control condition. In the embodiment, the collection restart timer is set to one hour, so that management information is scheduled to be collected every one hour. Alternatively, a schedule for collection of the management information may be appropriately selected according to a scale of the network or to the frequency of the update.

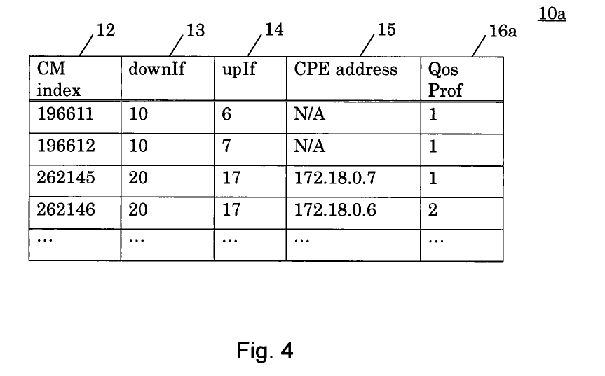

The bandwidth control setting storage unit 10 stores therein two tables, i.e., an IP address table 10a and a QoS profile table 10b. FIG. 4 shows an example of the IP address table 10a. The management information collecting unit 7 extracts “docsIfCmtsCmStatusIndex” allocated to each of the CMs 3a to 3c, “docsIfCmtsCmStatusDownChannelIfIndex” indicating an interface number of a downlink cable, and “docsIfCmtsCmStatusUpChannelIfIndex” indicating an interface number of an uplink cable from a “docsIfCmtsCmStatusTable” table that makes each of the CMs 3a to 3c correspond to the interface numbers of uplink and downlink cables connected to the CM on the CMTS 2, and writes them to an item of “CM identification number” 12, an item of “downlink interface” 13, and an item of “uplink interface” 14 corresponding to the CM in the IP address table 10a, respectively. The management information collecting unit 7 extracts “docsSubMgtCpeIpAddr” indicating the IP address of the terminal 21a, 21b or 21c connected to the CM having the CM identification number 12 from a “DocsSubMgtCpeIpTable” table that makes each of the CMs 3a to 3c correspond to the terminal connected to the CM, and writes the extracted “docsSubMgtCpeIpAddr” to an item of “IPaddress” 15 corresponding to the CM in the IP address table 10a. Further, the management information collecting unit 7 extracts “docsIfCmtsServiceQosProfile” indicating a service bandwidth type corresponding to the CM identification number 12 from a “docsIfCmtsServiceTable” table that makes each of the CMs 3a to 3c correspond to a QoS profile for the CM, and writes the extracted “docsIfCmtsServiceQosProfile” to an item of “QoS profile” 16a corresponding to the CM in the IP address table 10a.

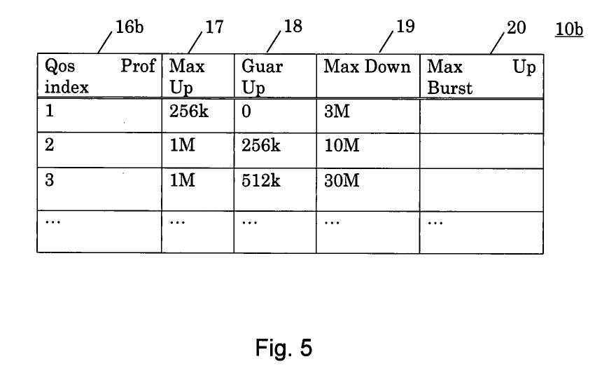

FIG. 5 shows an example of the QoS profile table 10b that makes each service bandwidth type correspond to a service content of the service bandwidth type. The same value as that written to the “QoS profile” 16a in the IP address table 10a is written to an item of “QoS profile” 16b, whereby the IP table 10a is made to correspond to the QoS profile table 10b. The management information collecting unit 7 extracts “docsIfQosProfMaxUpBandwidth” indicating a maximum uplink bandwidth (bps), “docsIfQosProfGuarUpBandwidth” indicating a guaranteed uplink bandwidth (bps), “docsIfQosProfMaxDownBandwidth” indicating a maximum downlink bandwidth (bps), and “docsIfQosProfMaxTxBurst” indicating a maximum uplink burst (mini-slots), each of which corresponds to the QoS profile, from a “docsQosProfileTable” table that makes bandwidth set values correspond to each QoS profile, and writes them to an index of “maximum uplink bandwidth” 17, an index of “guaranteed uplink bandwidth” 18, an index of “maximum downlink bandwidth” 19, and an index of “maximum uplink burst” 20 corresponding to the QoS profile in the QoS profile table 10b, respectively. While no value is set to the item of the maximum unlink burst 20 in the example of the QoS profile table 10b according to the embodiment shown in FIG. 5, this indicates that a value corresponding to a maximum uplink burst is not set in the acquired MIB.

Configurations of the respective tables stored in the bandwidth control setting storage unit 10 stated above are only an example in the embodiment. A technical scope of the present invention is not limited to the exemplary configurations of the tables.

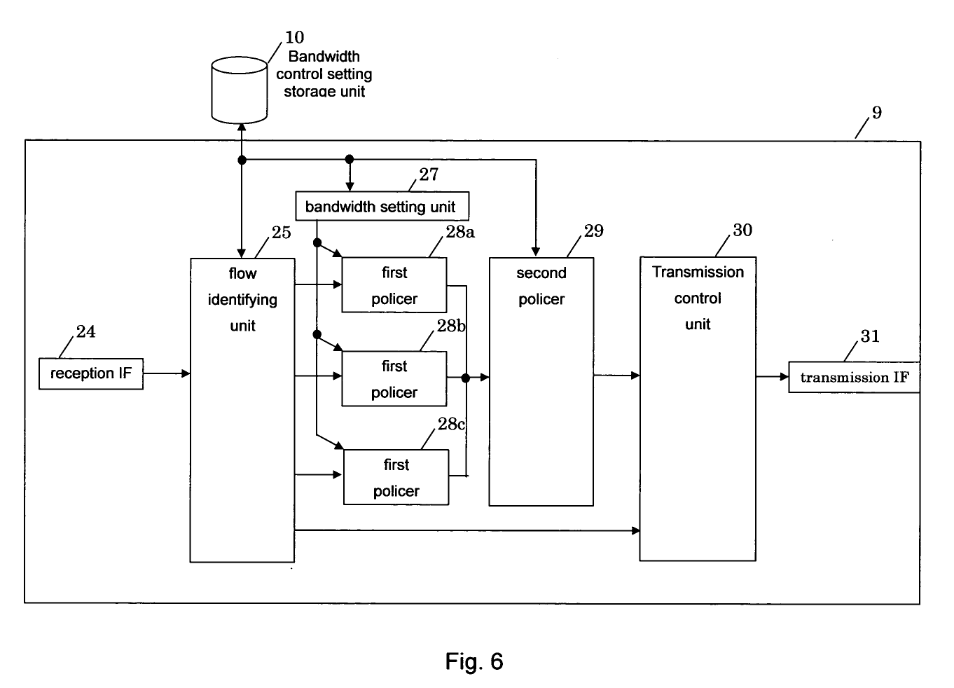

FIG. 6 is a block diagram showing a configuration of the traffic control unit 9. The traffic control unit 9 includes a reception interface (hereinafter “IF”) 24 receiving packets, a flow identifying unit 25 identifying a flow of the received packets, a bandwidth setting unit 27 setting a minimum guaranteed bandwidth per flow identified by the flow identifying unit 25, first policers 28a to 28c provided to correspond to respective flows, a second policer 29 limiting a transfer rate for transferring the packets the flow of which is identified by the flow identifying unit 25, a transmission control unit 30 limiting a transfer rate for transferring packets to be transmitted, and a transmission IF 13 transmitting packets.

In the embodiment, the term “flow” is used to mean a group of packets identical in a sender IP address or a destination IP address and transmitted or received as a group within relatively short time. Alternatively, even if packets are transmitted from a sender having an identical IP address, flows of the packets may be identified as different flows according to applications. In another alternative, a group of packets transmitted or received from/by a plurality of terminals may be identified as one flow. Based on what standard each flow is to be identified depends on a setting of the traffic shaper 1 according to the embodiment and does not limit the technical scope of the present invention.

The flow identifying unit 25 identifies a flow of packets received by the reception IF 24 based on the bandwidth control conditions stored in the bandwidth control setting storage unit 10, and outputs the packets to one of the first policers 28a to 28c according to the identified flow.

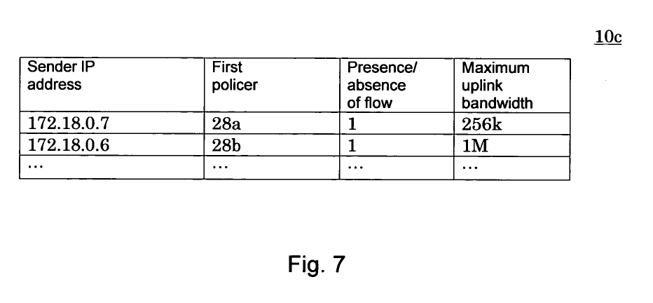

The bandwidth control setting storage unit 10 stores therein not only the IP address table 10a and the QoS profile table 10b but also a flow identification table 10c shown in, for example, FIG. 7. An instance of exercising a control over the bandwidth in a direction from each of the terminals 21a to 21c to the Internet, i.e., an uplink bandwidth control will be described. In an initial state, all items in the flow identification table 10c are blank. If the flow identifying unit 25 identifies a flow of packets a sender IP address of which is “172.18.0.7”, the flow identifying unit 25 searches the flow identification table 10c to check whether the sender IP address is stored in the flow identification table 10c. In the initial state, no sender IP addresses are stored in the flow identification table 10c. Therefore, the flow identifying unit 25 then searches the IP address table 10a stored in the bandwidth control setting storage unit 10 to check whether the sender IP address is stored in IP address table 10a. If the sender IP address is stored in the IP address table 10a, then the flow identifying unit 25 acquires a maximum uplink bandwidth, i.e., 256 kbps in the example of FIGS. 4 and 5, corresponding to the sender IP address by referring to the QoS profile table 10b, and sets the sender IP address and the maximum uplink bandwidth to the respective items in the flow identification table 10c. Next, if the flow identifying unit 25 selects one of the first policers 28a to 28c, e.g., 28a which is not allocated to the other flows, then the flow identifying unit 25 sets “28a” which is an identifier of the first policer 28a to the item of “first policer” in the flow identification table 10c, and outputs the identified flow of packets to the first policer 28a. If the flow identifying unit 25 next identifies a flow of packets a sender IP address of which is “172.18.0.7”, the flow identifying unit 25 outputs the packets to the first policer 28a. This is because the sender IP address “172.18.0.7” and the identifier 28a of the first policer 28a are already set to the respective items in the flow identification table 10c.

Furthermore, if the flow identifying unit 25 identifies a flow of packets a sender IP address of which is “172.18.0.6”, the flow identifying unit 25 searches the IP address table 10a stored in the bandwidth control setting storage unit 10 to check whether the sender IP address is stored in IP address table 10a. This is because the sender IP address is not stored in the flow identification table 10c. According to the example of FIGS. 4 and 5, a maximum uplink bandwidth corresponding to the sender IP address “172.18.0.6” is 1 Mbps. Therefore, the flow identifying unit 25 sets the sender IP address and the corresponding maximum uplink bandwidth to the respective items in the flow identification table 10c. Next, if the flow identifying unit 25 selects one of the first policers 28b or 28c, e.g., 28b which is not allocated to the other flow, then the flow identifying unit 25 sets “28b” which is an identifier of the first policer 28b to the item of “first policer” in the flow identification table 10c, and outputs the identified flow of packets to the first policer 28b.

In this case, if the sender IP address of the flow of packets identified by the flow identifying unit 25 is not stored in either the flow identification table 10c or the IP address table 10a, this means that the traffic control unit 9 has received the packets from a terminal having an IP address which the traffic shaper 1 does not recognize. Such packets are output to the transmission control unit 31.

As stated, in the embodiment, the flow identification based on the sender IP address has been described to explain the method of controlling the uplink bandwidth. To control a downlink bandwidth, it suffices that the flow identifying unit 25 identifies each flow of packets based on the sender IP address. In this case, the flow identification table 10c is created using numeric values stored in the respective items of maximum downlink bandwidth 19 in the QoS profile table 10b instead of those of “maximum uplink bandwidth” stored in the flow identification table 10c. If information on either the maximum uplink bandwidth or the maximum downlink bandwidth is not present in the acquired MIB, all of packets to be transmitted in this direction are not identified by the flow identifying unit 25 but transferred to the transmission control unit 30. In this case, a so-called best effort bandwidth control is exercised.

Alternatively, the flow identifying unit 25 may identify a flow of packets based on a sender port number or a destination port number, or identify packets sender or destination IP addresses of which are, for example, “172.18.0.*” as one flow by allocating a plurality of terminals to groups. In the former case, it is possible to control the used bandwidth per application. In the latter case, it is possible to control the used bandwidth per sub-network.

In FIG. 6, the traffic control unit 9 includes the three first policers 28a to 28c. However, the number of first policers is not limited to a specific number. Further, any one of the first policers 28a to 28c will be referred to as “first policer 28” hereinafter.

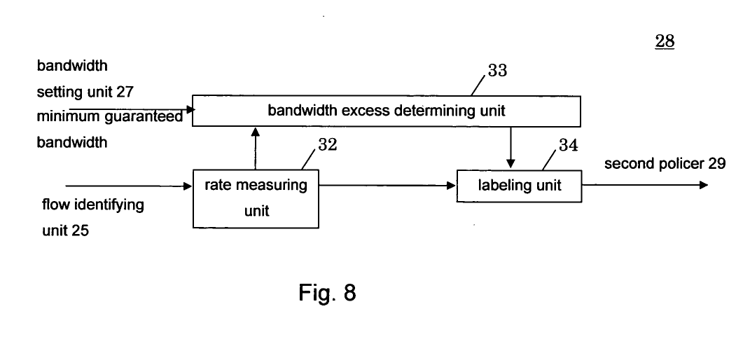

Referring to FIG. 8, the first policer 28 will be described. The first policer 28 includes a rate measuring unit 32 measuring a transfer rate for transferring packets, a bandwidth excess determining unit 33 determining whether the transfer rate measured by the rate measuring unit 32 exceeds a minimum guaranteed bandwidth, and a labeling unit 34 adding a label representing a determination result of the bandwidth excess determining unit 33 to each packet.

The rate measuring unit 32 measures the transfer rate based on an input time difference between an input packet and a packet input just before the input packet and sizes of respective packets.

The bandwidth excess determining unit 33 determines whether the transfer rate exceeds the minimum guaranteed bandwidth by comparing the transfer rate measured by the rate measuring unit 32 with the minimum guaranteed bandwidth set by the bandwidth setting unit 27.

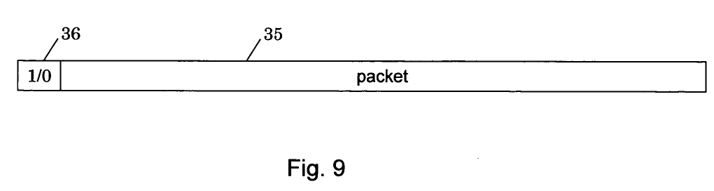

As shown in FIG. 9, the labeling unit 34 adds a first label 36, e.g., “1” to a packet 35 for which the bandwidth excess determining unit 33 determines that the packet 35 is input at the transfer rate equal to or lower than the minimum guaranteed bandwidth, and adds a second label 36, e.g., “0” to a packet 35 for which the bandwidth excess determining unit 33 determines that the packet 35 is input at the transfer rate exceeding the minimum guaranteed bandwidth.

In FIG. 6, the bandwidth setting unit 27 sets the minimum guaranteed bandwidth per flow identified by the flow identifying unit 25.

The flow identifying unit 25 is configured to include reception determining means determining whether reception of packets has stopped per flow besides identifying a flow of packets, and to set a determination result of the reception determining means to an item of “flow presence/absence” in the flow identification table 10c shown in FIG. 7.

Specifically, if identifying a flow of packets, the flow identifying unit 25 sets, for example, “1” to the item of “flow presence/absence” corresponding to the flow. If the flow of packets is not received within preset time, the flow identifying unit 25 sets, for example, “0” to the item of “flow presence/absence” corresponding to the flow.

The bandwidth setting unit 27 proportionally distributes a virtual limited bandwidth of the service line 4 the maximum uplink bandwidth per flow to the flow of packets for which “1” is set to the item of “flow presence/absence”, that is, to the flow of packets for which it is determined that reception of the packets has not stopped, thereby setting the minimum guaranteed bandwidth of each flow. In the example of FIG. 7, if the virtual limited bandwidth of the service line 4 is, for example, 1 Mbps, the bandwidth setting unit 27 sets a minimum guaranteed bandwidth of 200 kbps to the flow of packets the sender IP address of which is “172.18.0.7”, and 800 kbps to the flow of packets the sender IP address of which is “172.18.0.6”.

The virtual limited bandwidth means an upper limit of the transfer rate for transferring all the packets the flows of which are identified. The network administrator or the like sets the virtual limited bandwidth to the bandwidth control setting storage unit 10 via the user interface unit 6 so as not to exceed a limited bandwidth of the service line 4 (hereinafter, “transmission limited bandwidth”.

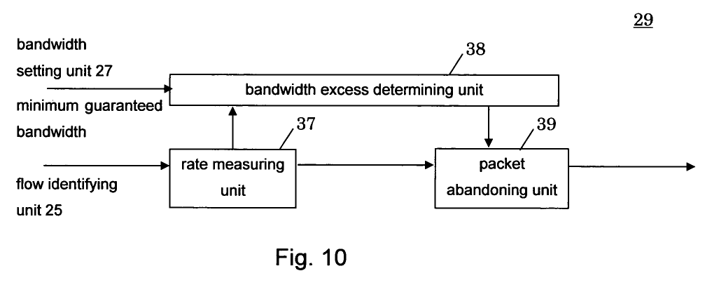

Referring to FIG. 10, the second policer 29 will next be described in detail. The second policer 29 includes a rate measuring unit 37 measuring a transfer rate for transferring each packet, a bandwidth excess determining unit 38 determining whether the transfer rate measured by the rate measuring unit 37 exceeds the virtual limited bandwidth, and a packet abandoning unit 38 abandoning the packet based on a determination result of the bandwidth excess determining unit 38.

The rate measuring unit 37 measures transfer rates for transferring all the packets input from the first policers 28a to 28c similarly to the rate measuring unit 32.

The bandwidth excess determining unit 38 determines whether the transfer rate exceeds the virtual limited bandwidth by comparing the transfer rate measured by the rate measuring unit 37 with the virtual limited bandwidth.

If the bandwidth excess determining unit 38 determines that the transfer rate exceeds the virtual limited bandwidth, the packet abandoning unit 39 abandons the packet, to which the second label “0” is added by the labeling unit 34 of the first policer 28, until the transfer rate becomes equal to or lower than the virtual limited bandwidth.

Further, the packet abandoning unit 39 removes the labels added by the labeling unit 34 of the first policer 28 from the non-abandoned packets, respectively.

In FIG. 6, the transmission control unit 30 permits transmission of packets output from the second policer 29, and limits transmission of packets that do not belong to any flows (hereinafter, simply “unidentified packets”).

Specifically, the transmission control unit 30 permits transmission of unidentified packets in a range in which the transfer rate for transferring packets to be relayed does not exceed the transmission limited bandwidth, and abandons unidentified packets in a range in which the transfer rate for transferring packets to be relayed exceeds the transmission limited bandwidth.

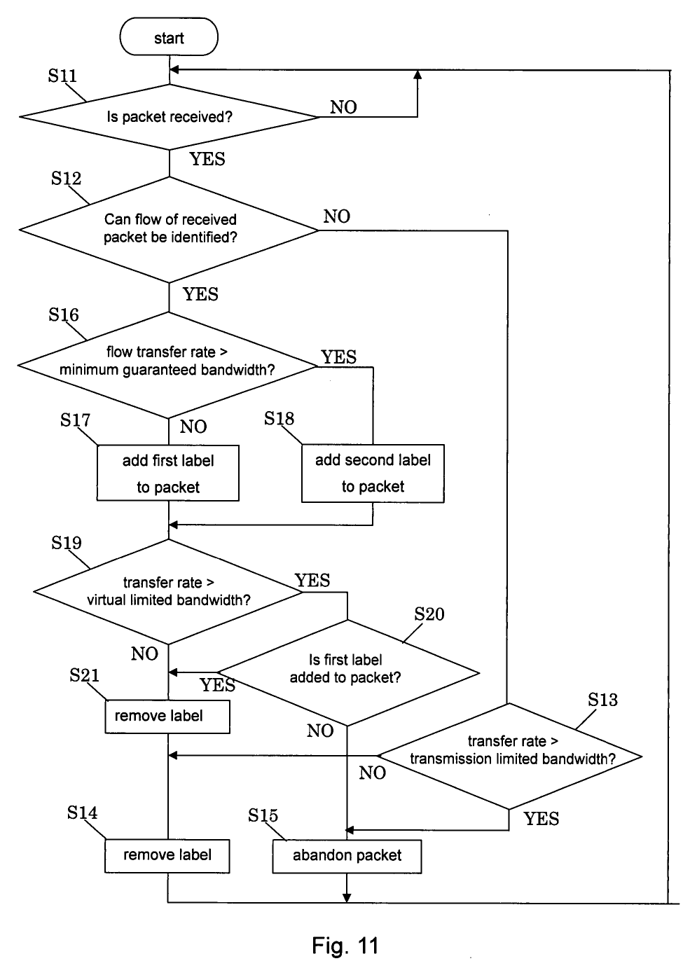

Operation performed by the traffic control unit 9 configured as stated above will be described with reference to FIG. 11.

First, when the reception IF 24 receives a packet (S1), the flow identifying unit 25 identifies a flow of the received packet (S12).

In this case, the sender IP address or destination IP address of the received packet is not set to the IP address table 10a stored in the bandwidth control setting storage unit 10. Due to this, if the flow identifying unit 25 does not identify the flow of the received packet (NO; S12), the transmission control unit 30 determines whether the transfer rate of the packet exceeds the transmission limited bandwidth (S13).

If the transmission control unit 30 determines that the transfer rate of the packet does not exceed the transmission limited bandwidth (NO; S13), the transmission control unit 30 permits the packet to be transmitted by the transmission IF 31 (S14). If the transmission control unit 30 determines that the transfer rate of the packet exceeds the transmission limited bandwidth (YES; S13), the transmission control unit 30 abandons the packet (S15).

If the flow identifying unit 25 identifies the flow of the received packet (YES; S12), the bandwidth exceed determining unit 33 of the first policer 28 determines whether the transfer rate of the packet exceeds the minimum guaranteed bandwidth (S16).

If the bandwidth exceed determining unit 33 determines that the transfer rate of the packet does not exceed the minimum guaranteed bandwidth (NO; S16), the labeling unit 34 of the first policer 28 adds the first label “1” to the packet (S17).

If the bandwidth exceed determining unit 33 determines that the transfer rate of the packet exceeds the minimum guaranteed bandwidth (YES; S16), the labeling unit 34 adds the second label “0” to the packet (S18).

The bandwidth excess determining unit 38 of the second policer 29 determines whether the transfer rate of the packet to which the label is added by the labeling unit 34 exceeds the virtual limited bandwidth (S19).

If the bandwidth exceed determining unit 38 determines that the transfer rate of the packet to which the label is added by the labeling unit 34 exceeds the virtual limited bandwidth (YES; S19), the packet abandoning unit 39 of the second policer 29 determines whether the label added to the packet is the first label “1” (S20).

If the packet abandoning unit 39 determines that the label added to the packet is not the first label “1”, that is, the second label “0” (NO; S20), the packet abandoning unit 39 abandons the packet (S15).

If the packet abandoning unit 39 determines that the label added to the packet is the first label “1” (YES; S20) or if the bandwidth exceed determining unit 38 determines that the transfer rate of the packet to which the label is added by the labeling unit 34 does not exceed the virtual limited bandwidth (NO; S19), the packet abandoning unit 39 removes the label added to the packet (S21) and the transmission IF 31 transmits the packet (S14).

In the embodiment, it has been described that the traffic control unit 9 includes a plurality of first policers 28a to 28c. Alternatively, the traffic control unit 9 according to the present invention may include one first policer and a storage region for each flow in place of the first policers 28a to 28c, an identification number of each flow, a minimum guaranteed bandwidth of the flow, and information for measuring a transfer rate of a packet such as a packet length and a packet arrival time may be stored in each storage region, and the first policer may process all flows of packets.

As stated above, the IP address of each of the terminals 21a to 21c is automatically allocated by a device (which is normally a DHCP server) present outside of the traffic shaper 1. Due to this, right after a new terminal is started or a new IP address is allocated to the existing terminal 21a, 21b or 21c, the traffic shaper 1 often receives a packet a sender IP address or a destination IP address of which is not stored in the IP address table 10a of the bandwidth control setting storage unit 10. In this case, it is decided whether to transmit or abandon the packet according to the procedure of the step S3 shown in FIG. 11. Therefore, in this case, the minimum guaranteed bandwidth is not set to a flow to be transmitted to the terminal. Nevertheless, information on the new IP address is promptly and automatically registered in the management information 11 stored in the CMTS 2. Further, as described in relation to the step S5 shown in FIG. 3, the management information collecting unit 7 regularly acquires the management information 11 according to the collection restart timer. In the embodiment, the collection restart timer is set to, for example, one hour. Due to this, the new IP address and corresponding bandwidth control conditions are acquired at least after one hour, and reflected in a storage content of the bandwidth control setting storage unit 10.

By thus configuring the traffic shaper 1, the traffic shaper 1 can exercise bandwidth controls over the respective terminals 2a to 2c even in a network system in which the bandwidth is shared among a plurality of terminals different in service bandwidth. Further, the MIB information is acquired regularly using the collection restart timer. Due to this, even if the IP addresses of the terminals 2a to 2c dynamically change or the network administrator updates the MIB information in the CMTS 2, changed bandwidth setting conditions are automatically reflected in the traffic shaper 1.

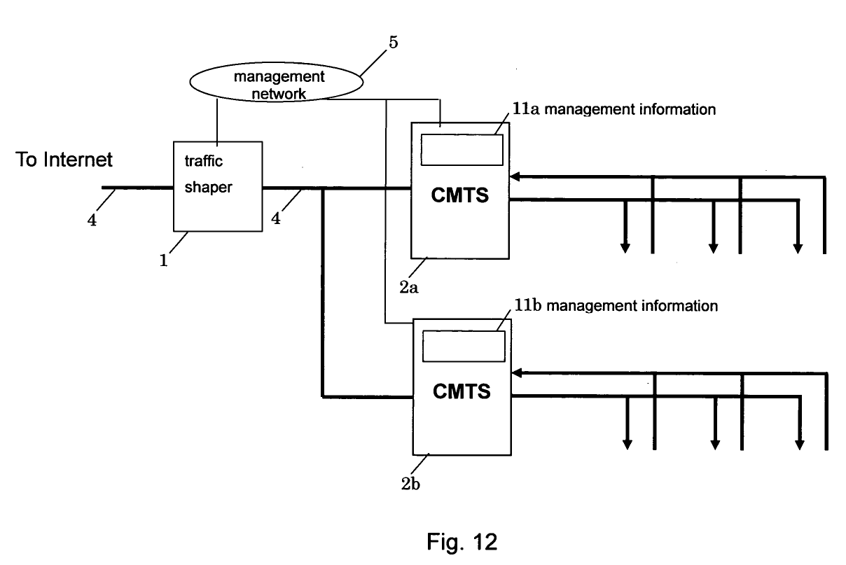

As already stated, the number of CMTS 2 connected to the traffic shaper 1 according to the present invention is not limited to one but may be an arbitrary number. By way of example, FIG. 12 shows another embodiment of connecting two CMTSs 2a and 2b to the traffic shaper 1. The embodiment in which a plurality of CMTSs 2a and 2b is connected to the traffic shaper 1 has the following two advantages over an instance in which each CMTS 2 includes therein a bandwidth control function. First, overall cost including a plurality of CMTSs 2a and 2b and the traffic shaper can be suppressed low. Second, the bandwidth control can be exercised over the CMTSs 2a and 2b collectively. For example, if a plurality of CMTSs 2a and 2b shares a service line for connecting to the Internet, a bandwidth used by certain one of the CMTSs 2a and 2b has room to spare and a bandwidth used by another CMTS becomes insufficient, then the traffic shaper 1 according to the embodiment of the present invention enables the CMTS the bandwidth used by which is insufficient to use a larger bandwidth. If the traffic shaper 1 according to the embodiment is not present and each CMTS 2a or 2b includes therein the bandwidth control function, it is difficult to realize accommodating the CMTS 2a or 2b having the insufficient bandwidth with the bandwidth in such a shared portion.

What is claimed is:

1. A traffic shaper connected between a relay apparatus connecting a plurality of access endpoints different in service bandwidth to the traffic shaper and an external network, and connected to a management network managing the relay apparatus, comprising:
a management information collecting unit connected to the management network, and collecting management information stored in a specific device outside of the traffic shaper, including identification information and service bandwidth information on each of the access endpoints, and changeable over time, from the specific device via the management network;
a bandwidth control setting storage unit storing a bandwidth control condition extracted from the management information collected by the management information collecting unit, and including the identification information and the service bandwidth information; and
a traffic control unit controlling a bandwidth available to each of the plurality of access endpoints based on the bandwidth control condition stored in the bandwidth control setting storage unit.

2. The traffic shaper according to claim 1,
wherein the external network is Internet.

3. The traffic shaper according to claim 2,
wherein the management information collecting unit regularly collects the management information.

4. The traffic shaper according to claim 3,
wherein the access endpoints are terminals, and
the identification information is an IP address of each of the terminals.

5. The traffic shaper according to claim 4,
wherein the service bandwidth information includes at least one of a maximum uplink bandwidth and a maximum downlink bandwidth to be controlled to correspond to each of the access endpoints.

6. The traffic shaper according to claim 5,
wherein the specific device is a plurality of devices, and
the management information control unit collects the management information from each of the specific devices.

7. The traffic shaper according to claim 5,
wherein the specific device is the relay apparatus.

8. The traffic shaper according to claim 6,
wherein the specific device is the relay apparatus.

9. The traffic shaper according to claim 5,
wherein the management information is stored in an MIB in the specific device, and
the management information collecting unit includes a function of an SNMP manager acquiring the MIB.

10. The traffic shaper according to claim 6,
wherein the management information is stored in an MIB in the specific device, and
the management information collecting unit includes a function of an SNMP manager acquiring the MIB.

11. The traffic shaper according to claim 7,
wherein the management information is stored in an MIB in the specific device, and
the management information collecting unit includes a function of an SNMP manager acquiring the MIB.

12. The traffic shaper according to claim 8,
wherein the management information is stored in an MIB in the specific device, and
the management information collecting unit includes a function of an SNMP manager acquiring the MIB.

13. The traffic shaper according to claim 5,
wherein the relay apparatus is a CMTS.

14. The traffic shaper according to claim 6,
wherein the relay apparatus is a CMTS.

15. The traffic shaper according to claim 7,
wherein the relay apparatus is a CMTS.

16. The traffic shaper according to claim 8,
wherein the relay apparatus is a CMTS.

17. The traffic shaper according to claim 9,
wherein the relay apparatus is a CMTS.

18. The traffic shaper according to claim 10,
wherein the relay apparatus is a CMTS.

19. The traffic shaper according to claim 11,
wherein the relay apparatus is a CMTS.

20. The traffic shaper according to claim 12,
wherein the relay apparatus is a CMTS.
